(19) United States
(12) Patent Application Publication
(10) Pub. No.: US 2010/0212762 A1
(43) Pub. Date: Aug. 26, 2010

(54) MICROFLUIDIC SYSTEM BASED ON ACTUATOR ELEMENTS

(75) Inventors: Jacob M. J. Den Toonder, AE Eindhoven (NL); Menno W.J. Prins, AE Eindhoven (NL); Francis Fahrni, AE Eindhoven (NL); Leonardus J. Van Dzendoorn, AE Eindhoven (NL)

Correspondence Address: NIXON & VANDERHYE, PC, 901 NORTH GLEBE ROAD, 11TH FLOOR, ARLINGTON, VA, 22203, US

(73) Assignee: Stitching Dutch Polymer Institute, Ax Eindhoven (NL)

(21) Appl. No.: 12/530,673

(22) PCT Filed: Mar. 10, 2008
(86) PCT No.: PCT/IB2008/050857

§ 371 Date: Apr. 22, 2010

(30) Foreign Application Priority Data
Mar. 12, 2007 (EP) 07103935.8

(51) Int. Cl. F15C 1/00

(52) U.S. Cl. 137/803

(57) ABSTRACT

The present invention provides a microfluidic system comprising a plurality of ciliary actuator elements (10) located at an inner surface (14) of a wall (15) of a microchannel (16) of the microfluidic system at a first location. The microfluidic system furthermore comprises a magnetic field generator formed by at least one current wire (17) integrated in the wall (15) of the micro channel (16) at a second location substantially opposite to the first location with respect to a centre line of the microchannel (16). The present invention also provides a method for the manufacturing of such microfluidic systems and to a method for controlling a fluid flow through a microchannel (16) of such a microfluidic system.

### FIELD OF THE INVENTION

The present invention relates to microfluidic systems, to a method for the manufacturing of microfluidic systems and/or to a method for controlling or manipulating a fluid flow through a microchannel of micro fluidic systems, as well as to a controller for controlling a fluid flow through a microchannel of a microfluidic system, and software for use with a microfluidic system in a method for controlling a fluid flow. The microfluidic systems may be used, for example, in biotechnological and pharmaceutical applications and in microchannel cooling systems in microelectronics applications. Microfluidic systems according to embodiments of the present invention can be compact, cheap and easy to process.

### BACKGROUND OF THE INVENTION

Microfluidics relates to a multidisciplinary field comprising physics, chemistry, engineering and biotechnology that studies the behaviour of fluids at volumes thousands of times smaller than a common droplet. Microfluidic components form the basis of so-called “lab-on-a-chip” devices or biochip networks that can process microliter and nanoliter volumes of fluid and conduct highly sensitive analytical measurements. The fabrication techniques used to construct microfluidic devices are relatively inexpensive and are amenable both to highly elaborate, multiplexed devices and also to mass production. In a manner similar to that for microelectronics, microfluidic technologies enable the fabrication of highly integrated devices for performing several different functions on a same substrate chip.

Microfluidic chips are becoming a key foundation to many of today's fast-growing biotechnologies, such as rapid DNA separation and sizing, cell manipulation, cell sorting and molecule detection. Microfluidic chip-based technologies offer many advantages over their traditional macro-sized counterparts. Microfluidics is a critical component in, amongst others, gene chip and protein chip development efforts.

In all micro fluidic devices, there is a basic need for controlling the fluid flow, that is, fluids must be transported, mixed, separated and directed through a microchannel system comprising channels with a typical width of about 0.1 mm. A challenge in microfluidic actuation is to design a compact and reliable microfluidic system for regulating or manipulating the flow of complex fluids of variable composition, e.g. saliva and full blood, in microchannels. Various actuation mechanisms have been developed and are at present used, such as, for example, pressure-driven schemes, microfabricated mechanical valves and pumps, inkjet-type pumps, electro-kinetically controlled flows, and surface-acoustic waves.

For example, in the case of mixing, a prevailing laminar flow in microfluidic channels, due to a low Reynolds number, usually only allows mixing by diffusion which is a rather slow process. Up to now, passive structures or ultrasonic waves are used to enhance the mixing. Nevertheless, passive structures need to be relatively large and a long time is needed for good mixing to occur. Ultrasonic waves on the other hand are spatially not well confined. Finally, both passive structures and ultrasonic waves do not provide effective mixing.

The application of micro-electromechanical systems (MEMS) technology to microfluidic devices has spurred the development of micro-pumps to transport a variety of liquids at a large range of flow rates and pressures.

In patent application WO 2006/087655 a microfluidic system is proposed based on actuator elements attached at one end to a microchannel wall. The actuator elements can be set in motion by changing their shape by applying an external stimulus. According to one embodiment, the external stimulus is a magnetic field. The channel wall of the microfluidic system is thus covered with the actuator elements and their concerted change in shape, e.g. from a curled shape into a straight shape, sets a fluid which is present in the channel in motion. The covering of the walls with the actuator elements may, for example, be done in a two-dimensional array fashion. By individually addressing the actuator elements or by addressing rows of actuator elements, a wave-like movement, an otherwise correlated movement, or an uncorrelated movement may be generated that can be advantageous in transporting, mixing or creating vortices.

FIG. 1 illustrates a basic principle of an actuator element 30 which is attached to a wall 35 of a channel 36 and which is magnetically actuated. One way to enable magnetic actuation of the actuator element 30 is by incorporating superparamagnetic particles in the actuator element 30. In the example given in FIG. 1, a spatially varying magnetic field is applied by a current wire 41 located in the wall 35 of the channel 36. Because of the location of the current wire 41, i.e. underneath the actuator element 30, the actuator element 30 experiences a magnetic field gradient towards the current wire 41. The magnetic field will be larger close to the wall 35 of the channel 36 than further away from the wall 35. For example, in FIG. 1, at location A, the magnetic field will be larger than at location B, and at location B the magnetic field will be larger than at location C. The magnetic force acts on the actuator element 30 in the direction of the gradient of the magnetic field, i.e. towards the current wire 41.

The application of an external magnetic field \vec{H} will result in translational forces on the actuator elements 30. The translational force equals:

$$\vec{F} = {μ}_{0} {\int }_{V} ( \vec{M} \cdot \vec{▽} ) \vec{{H}_{0}} d V \qquad ( 1 )$$

wherein \vec{M} is the magnetization of the actuator element 30, μ₀=4π10⁻⁷ is the permeability of free space, V is the volume of the actuator element 30 and \vec{H₀} is the magnetic field in absence of the actuator element 30.

In actuator elements 30 suitable for use in a micro fluidic device, the resulting force \vec{F} acting on the actuator element 30, on the one hand, must be sufficient to significantly bend the actuator element 30, i.e. to overcome the stiffness of the actuator element 30, and on the other hand must be large enough to exceed the drag acting upon the actuator element 30 by the surrounding fluid present in the channel 36. To achieve this, the magnetic field gradient at the position of the actuator element 30 must be sufficiently large, especially at the tip of the actuator element 30 where the magnetic force is most effective in causing bending.

Location of a current wire 41 integrated in the wall 35 of the channel 36 of the microfluidic system, as illustrated in FIG. 1, may not be most effective because the magnetic field gradient falls off rapidly as 1/r² and the force acting on the actuator element 30 falls off as 1/r³, wherein r is the distance between a location (e.g. A, B, C) on the actuator element 30 and the current wire 41. Therefore, in order to obtain a sufficient force, quite large currents, which may in some cases, depending on the application and on the elastic modulus and shape of the actuator element 30, be higher than 10 A, are to be sent through the current wire 41 in order to actuate or get sufficient bending of the actuator element 30 to be suitable for use in microfluidic systems as described above.

### SUMMARY OF THE INVENTION

It is an object of the present invention to provide a good micro fluidic system and/or a method of manufacturing and/or operating the same.

An advantage of the micro fluidic system according to embodiments of the present invention is that, because of the use of magnetic actuation, they may work with very complex, non-magnetic biological fluids such as e.g. saliva, sputum or full blood.

A further advantage of the microfluidic system according to embodiments of the present invention is that it provides enhanced actuation effects at equal or lower electrical currents with respect to prior art microfluidic systems in which magnetic actuation is obtained by a magnetic field generated by a current wire located in the wall of the microchannel to which the actuator element is attached.

The microfluidic systems according to embodiments of the present invention are economical and simple to process, while also being robust and compact and suitable for complex fluids.

The above objective is accomplished by a method and device according to the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

In a first aspect of the invention, a micro fluidic system is provided. The microfluidic system comprises at least one microchannel having a wall and a centre line along its length. The micro fluidic system furthermore comprises:

a plurality of ciliary actuator elements attached to a surface of the wall at a first location, each ciliary actuator element having a shape and an orientation, and a magnetic field generator for applying a magnetic field to the plurality of ciliary actuator elements so as to cause a change in their shape and/or orientation.

The magnetic field generator for applying the magnetic field to the plurality of ciliary actuator elements is formed by at least one current wire integrated in the wall of the microchannel at a second location, the second location being substantially opposite to the first location with respect to the centre line of the microchannel.

An advantage of the microfluidic device according to embodiments of the invention is that it provides enhanced actuation effects at equal or lower electrical currents with respect to prior art microfluidic systems in which magnetic actuation is obtained by a magnetic field generated by a current wire located in the wall of the microchannel at the first location.

According to embodiments of the invention, the plurality of ciliary actuator elements being positioned subsequently in a row, the micro fluidic system may comprise a plurality of current wires integrated in the wall of the micro fluidic system at the second location and a current wire may be located in between each two subsequent ciliary actuator elements. Preferably, a distance between a ciliary actuator element and a first current wire may, according to embodiments of the invention, be lower than a distance between the ciliary actuator element and a second current wire or vice versa. In this case, the positioning of the current wires is asymmetric with respect to the positioning of the ciliary actuator elements so that one single ciliary actuator element may be mainly addressed by a single current wire. According to other embodiments, the distance between the ciliary actuator element and the first current wire may be equal to the distance between the ciliary actuator element and the second current wire. In this case, a current wire may be positioned in the middle in between two subsequent ciliary actuator elements. According to these embodiments, both ciliary actuator elements in between which the current wire is located will be actuated at a same time.

According to other embodiments, the microfluidic system may comprise a plurality of current wires integrated in the wall of a microchannel at the second location and a separate current wire may be provided for each of the plurality of ciliary actuator elements. An advantage of these embodiments is that each of the ciliary actuator elements may be addressed individually.

According to still further embodiments of the invention, the wall of the microchannel may have at least one protrusion at the second location and the at least one current wire may be located in the at least one protrusion of the wall of the microchannel. In these cases, the current wire can be brought even closer to the tip of the ciliary actuator elements than in case no protrusions are provided. Hence, with respect to prior art microfluidic systems, the current required for actuating the ciliary actuator elements may be lower than is the case in the embodiments of the invention where no protrusions are provided.

The at least one protrusion may show an overlap with the ciliary actuator elements of between 0 μm and 10 μm.

According to some embodiments of the invention, the micro fluidic system may furthermore comprise an external magnetic field generator.

The plurality of ciliary actuator elements may preferably be polymer actuator elements. The polymer actuator elements may, for example, comprise polymer MEMS. According to specific embodiments of the invention, the polymer actuator elements may comprise an Ionomeric Polymer-Metal Composite (IPMC).

In order to provide the ciliary actuator elements with magnetic properties, the ciliary actuator elements may, according to embodiments of the invention, comprise a uniform continuous magnetic layer. According to other embodiments, the ciliary actuator elements may comprise a patterned continuous magnetic layer. According to still further, preferred embodiments, the ciliary actuator elements may comprise magnetic particles.

Furthermore, the microfluidic system may comprise at least one magnetic sensor for measuring movement of the plurality of ciliary actuator elements.

According to specific examples, the microfluidic system may furthermore comprise at least one stopper element for limiting the movement of at least one ciliary actuator element.

The microfluidic system according to embodiments of the invention may be used in biotechnological, pharmaceutical, electrical or electronic applications.

In a further aspect of the invention, a method is provided for the manufacturing of a microfluidic system comprising at least one microchannel having a centre line along its length. The method comprises:

providing an inner surface of a wall of the at least one microchannel with a plurality of ciliary actuator elements attached at a first location, and

providing at least one current wire in the wall of the at least one microchannel at a second location,

wherein the second location is substantially opposite to the first location with respect to the centre line of the microchannel.

The method according to the invention leads to a microfluidic system which shows enhanced actuation effects at equal or lower electrical currents with respect to prior art microfluidic systems in which magnetic actuation is obtained by a magnetic field generated by a current wire located in the wall of the microchannel at the first location.

According to embodiments of the invention, the method may comprise providing a plurality of current wires and providing the plurality of current wires may be performed by providing a current wire in between each two subsequent ciliary actuator elements. Preferably, providing the plurality of current wires may be performed such that a distance between a ciliary actuator element and a first current wire may, according to embodiments of the invention, be lower than a distance between the ciliary actuator element and a second current wire or vice versa. In this case, the positioning of the current wires is asymmetric with respect to the positioning of the ciliary actuator elements so that one single ciliary actuator element may be mainly addressed by a single current wire. According to other embodiments, providing the plurality of current wires may be performed such that the distance between the ciliary actuator element and the first current wire is equal to the distance between the ciliary actuator element and the second current wire. In this case, a current wire may be positioned in the middle in between two subsequent ciliary actuator elements. According to these embodiments, both ciliary actuator elements in between which the current wire is located will be actuated at a same time.

According to other embodiments, the method may comprise providing a plurality of current wires. Providing the plurality of current wires may be performed by providing a separate current wire for each of the plurality of ciliary actuator elements. The method according to these embodiments leads to a microfluidic system in which each of the ciliary actuator elements can be addressed individually.

According to further embodiments of the invention, the method may furthermore comprise providing at least one protrusion to the wall of the microchannel at the second location. Providing the at least one current wire may be performed by providing the at least one current wire in the at least one protrusion of the wall. According to these embodiments, the current wire can be brought even closer to the tip of the ciliary actuator elements than in case no protrusions are provided. Hence, with respect to prior art microfluidic systems, the method according to embodiments of the invention leads to microfluidic systems in which the current required for actuating the ciliary actuator elements may be lower than is the case in the embodiments of the invention where no protrusions are provided.

According to some embodiments of the invention, the method may furthermore comprise providing at least one stopper element for limiting the movement of at least one ciliary actuator element.

In another aspect of the invention, a method is provided for controlling a fluid flow through a microchannel of a microfluidic system, the microchannel having a centre line along its length and a wall, the wall of the microchannel having a plurality of ciliary actuator elements at a first location, the ciliary actuator elements each having a shape and an orientation. The method comprises providing a current through at least one current wire present in the wall of the microchannel at a second location substantially opposite to the first location with respect to the centre line of the microchannel for applying a magnetic field to the ciliary actuator elements so as to cause a change in the shape and/or orientation of at least one ciliary actuator element.

Providing a current through at least one current wire may be performed by providing a current of between 0.1 A and 10 A. Preferably, providing a current through at least one current wire may be performed by providing a current of between 0.1 A and 1 A.

The method for controlling a fluid flow through a microchannel of a microfluidic system according to embodiments of the invention may be used in biotechnological, pharmaceutical, electrical or electronic applications.

In still a further aspect of the invention, a controller is provided for controlling a fluid flow through a microchannel of a microfluidic system, the microchannel having a centre line along its length and a wall, the wall of the microchannel having a plurality of ciliary actuator elements at a first location, the ciliary actuator elements each having a shape and an orientation. The controller comprises a control unit for controlling flowing of a current through at least one current wire present in the wall of the microchannel at a second location substantially opposite to the first location with respect to the centre line of the microchannel for applying a magnetic field to the ciliary actuator elements so as to cause a change in the shape and/or orientation of at least one ciliary actuator element.

The present invention also provides a computer program product for performing, when executed on a computing means, the method for controlling a fluid flow through a microchannel of a microfluidic system according to embodiments of the present invention.

Furthermore, the present invention provides a machine readable data storage device for storing the computer program product according to embodiments of the invention and transmission of the computer program product according to embodiments of the invention over a local or wide area telecommunications network.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 illustrates a superparamagnetic ciliary actuator element actuated in a non-homogeneous magnetic field induced by a current wire according to the prior art.

FIG. 2 illustrates an example of a ciliary beat cycle showing the effective and recovery strokes.

FIG. 3 illustrates a wave of cilia showing their co-ordination in a metachronic wave.

FIG. 4 illustrates a ciliary actuator element comprising a continuous magnetic layer according to an embodiment of the present invention.

FIG. 5 schematically illustrates a ciliary actuator element comprising magnetic particles according to an embodiment of the present invention.

FIGS. 6 and 7 illustrate part of a microfluidic system according to an embodiment of the invention.

FIG. 8 illustrates part of a micro fluidic system according to another embodiment of the invention.

FIG. 9 illustrates part of a microfluidic system according to yet another embodiment of the invention.

FIGS. 10 and 11 illustrate part of a microfluidic system according to still another embodiment of the invention.

FIG. 12 shows the direction of the gradient of the magnetic field in case an external magnetic field is superposed to the magnetic field generated by the current wire located in the wall of the microchannel according to embodiments of the invention.

FIG. 13 shows a finite element simulation of a ciliary actuator element actuated by current wires located at different locations.

FIGS. 14, 15 and 16 illustrate applications of the microfluidic system according to embodiments of the present invention.

FIG. 17 illustrates part of a microfluidic system according to embodiments of the invention and its principle of functioning.

FIG. 18 illustrates a bending ciliary actuator element and a responsive surface covered with such bending ciliary actuator element according to an embodiment of the present invention.

FIG. 19 is a schematic illustration of a bending ciliary actuator element according to an embodiment of the present invention.

FIG. 20 schematically illustrates a system controller for use with a microfluidic system according to embodiments of the present invention.

FIG. 21 is a schematic representation of a processing system as can be used for performing a method for controlling a fluid flow through a microchannel of a microfluidic system according to embodiments of the present invention.

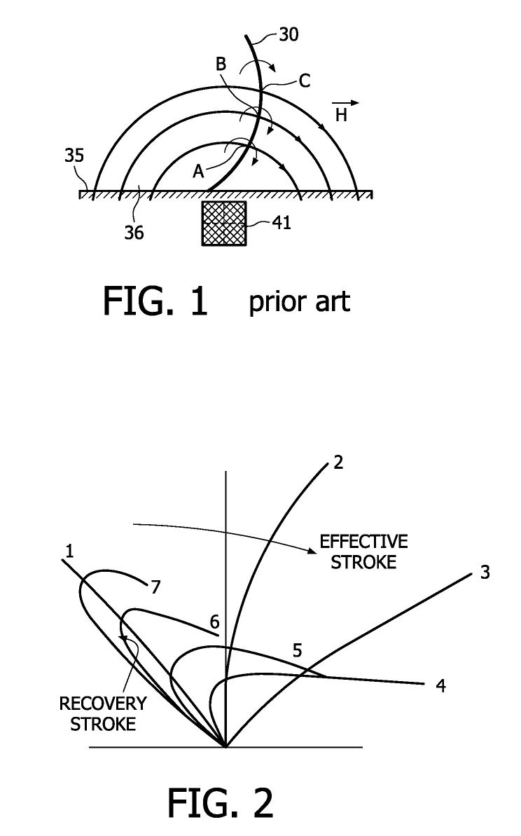

In the different figures, the same reference signs refer to the same or analogous elements.

### DETAILED DESCRIPTION OF THE EMBODIMENTS

The present invention will be described with respect to particular embodiments and with reference to certain drawings but the invention is not limited thereto but only by the claims. Any reference signs in the claims shall not be construed as limiting the scope. The drawings described are only schematic and are non-limiting. In the drawings, the size of some of the elements may be exaggerated and not drawn on scale for illustrative purposes.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms above and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may do so. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

In a first aspect, the present invention provides a microfluidic system provided with magnetic actuators, e.g. magnetic actuation means which allow transportation or (local) mixing or directing of fluids through microchannels of a microfluidic system. In a second aspect, the present invention provides a method for the manufacturing of such a microfluidic system. In a third aspect, the present invention provides a method for controlling fluid flow through microchannels of a microfluidic system.

The microfluidic systems according to embodiments of the present invention are economical and simple to process, while also being robust and compact and suitable for complex fluids.

A microfluidic system according embodiments of the present invention comprises at least one microchannel having a wall and a centre line along its length. The microfluidic system furthermore comprises a plurality of ciliary actuator elements attached to the wall of the at least one microchannel at a first location, each ciliary actuator element having a shape and an orientation. Further means for applying stimuli, i.e. a magnetic field, to the plurality of ciliary actuator elements are provided so as to cause a change in the shape and/or orientation of the ciliary actuator elements. According to embodiments of the present invention, the means for applying stimuli, i.e. a magnetic field, to the plurality of ciliary actuator elements is formed by at least one current wire integrated in the wall of the microchannel at a second location, the second location being substantially opposite to the first location with respect to the centre line of the microchannel.

The microfluidic system according to the invention may be used in biotechnological applications, such as micrototal analysis systems, bioreactors, microfluidic diagnostics, micro-factories and chemical or biochemical micro-plants, biosensors, rapid DNA separation and sizing, cell manipulation and sorting, in pharmaceutical applications, in particular high-throughput combinatorial testing where local mixing is essential, and in microchannel cooling systems e.g. in microelectronics applications.

In one aspect of the invention, the way in which the actuator elements are envisioned to work is inspired by nature. Nature knows various ways to manipulate fluids at small scales, i.e. 1-100 micron scales. One particular mechanism found is that due to a covering of beating cilia over the external surface of micro-organisms, such as, for example, paramecium, pleurobrachia, and opaline. Ciliary motile clearance is also used in the bronchia and nose of mammals to remove contaminants. A cilium can be seen as a small hair or flexible rod which in, for example, protozoa may have a typical length of 10 μm and a typical diameter of 0.1 μm, attached to a surface. Apart from a propulsion mechanism for micro-organisms, other functions of cilia are in cleansing of gills, feeding, excretion and reproduction. The human trachea, for example, is covered with cilia that transport mucus upwards and out of the lungs. Cilia are also used to produce feeding currents by sessile organisms that are attached to a rigid substrate by a long stalk. The combined action of the cilia movement with the periodic lengthening and shortening of the stalk induces a chaotic vortex. This results in chaotic filtration behaviour of the surrounding fluid.

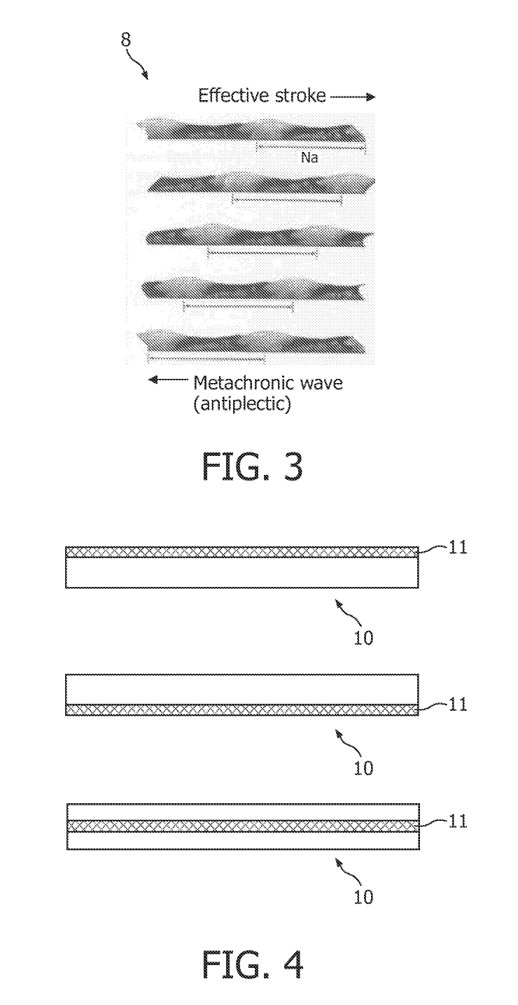

The above discussion illustrates that cilia can be used for transporting and/or mixing fluid in microchannels. The mechanics of ciliary motion and flow has interested both zoologists and fluid mechanists for many years. The beat of a single cilium can be separated into two distinct phases i.e. a fast effective stroke (curves 1 to 3 of FIG. 2) when the cilium drives fluid in a desired direction and a recovery stroke (curves 4 to 7 of FIG. 2) when the cilium seeks to minimise its influence on the generated fluid motion. In nature, fluid motion is caused by high concentrations of cilia in rows along and across the surface of an organism. The movements of adjacent cilia in one direction are out of phase, this phenomenon is called metachronism. Thus, the motion of cilia appears as a wave passing over the organism. FIG. 3 illustrates such a wave 8 of cilia showing their co-ordination in a metachronic wave. A model that describes the movement of fluid by cilia is published by J. Blake in ‘A model for the micro-structure in ciliated organisms’, J. Fluid. Mech. 55, p. 1-23 (1972). In this article, it is described that the influence of cilia on fluid flow is modelled by representing the cilia as a collection of “Stokeslets” along their centreline, which can be viewed as point forces within the fluid. The movement of these Stokeslets in time is prescribed, and the resulting fluid flow can be calculated. Not only the flow due to a single cilium can be calculated, also that due to a collection of cilia covering a single wall with an infinite fluid layer on top, moving according to a metachronic wave.

The approach in a preferred aspect of the present invention makes use of this principle to mimic the cilia-like fluid manipulation in microchannels by covering the walls of the microchannels with “artificial cilia” based on microscopic actuator elements, i.e. structures changing their shape and/or dimension in response to an applied magnetic field. Hence, one aspect of the present invention provides a microfluidic system or microfluidic flow device such as a pump having means for artificial ciliary metachronic activity.

According to the invention, all suitable materials, i.e. materials that are able to change their shape by, for example, mechanically deforming as a response to an applied magnetic field may be used for forming the artificial ciliary or ciliary actuator elements.

According to most preferred embodiments of the invention, the actuator elements may be based on polymer materials. Suitable materials may be found in the book “Electroactive Polymer (EAP) Actuators as Artificial Muscles”, ed. Bar-Cohen, SPIE Press, 2004. However, also other materials may be used for the actuator elements. The materials that may be used to form actuator elements according to the present invention should be such that the formed actuator elements have the following characteristics:

the actuator element should be compliant, i.e. not stiff,

the actuator element should be tough, not brittle,

the actuator elements should respond to a magnetic field by bending or changing shape, and

the actuator elements should preferably be easy to process by means of relatively cheap processes.

The material that is used to form the actuator elements may have to be functionalized. Considering the first, second and fourth characteristic of the above summarized list, polymers are preferred for at least a part of the actuators. Most types of polymers can be used according to the present invention, except for very brittle polymers such as e.g. polystyrene which are not very suitable for use with the present invention.

Because of the above, according to the present invention, the actuator elements may preferably be formed of, or include as a part of their construction, polymer materials. Therefore, in the further description, the invention will be described by means of polymer actuator elements. However, it has to be understood by a person skilled in the art that the present invention may also be applied when other materials than polymers, as described above, are used to form the actuator elements. Polymer materials are, generally, tough instead of brittle, relatively cheap, elastic up to large strains (up to 10%) and offer perspective of being processable on large surface areas with simple processes.

According to embodiments of the present invention, to obtain magnetic actuation, metals may be also used to form at least part of the actuator elements, e.g. in Ionomeric Polymer-Metal composites (IPMC). For example, FeNi or another magnetic material may be used to form the actuator elements. A disadvantage of metals, however, could be mechanical fatigue and cost of processing.

According to other embodiments, to be able to actuate the actuator elements by applying a magnetic field, the actuator elements must be provided with magnetic properties.

One way to provide a non-magnetic, e.g. polymer, actuator element 10 with magnetic properties is by incorporating a continuous magnetic layer 11 in the non-magnetic, e.g. polymer, actuator element 10, as shown in the different embodiments represented in FIG. 4. The actuator elements 10 with magnetic properties will in the further description be referred to as magnetic actuator elements 10 or as polymer actuator elements 10 with magnetic properties. The continuous magnetic layer 11 may be positioned at the top (upper drawing of FIG. 4) or at the bottom of the actuator element 10 (drawing in the middle of FIG. 4), or may be situated in the body, e.g. centre, of the actuator element 10 (lower drawing of FIG. 4). The position of the continuous magnetic layer 11, together with its thermo-mechanical properties, determine the “natural”, initial or non-actuated shape of the magnetic actuator element 10, i.e. flat, curled upward or curled downward. The continuous magnetic layer 11 may, for example, be an electroplated Permalloy (e.g. Ni—Fe) and may, for example, be deposited as a uniform layer. The continuous magnetic layer 11 may have a thickness of between 0.1 and 10 μm. The direction of easy magnetization may be determined by the deposition process and may, in the example given, be the ‘in-plane’ direction. Instead of a uniform layer, the continuous magnetic layer 11 may also be patterned (not shown in the drawings) to increase the compliance and ease of deformation of the magnetic actuator elements 10.

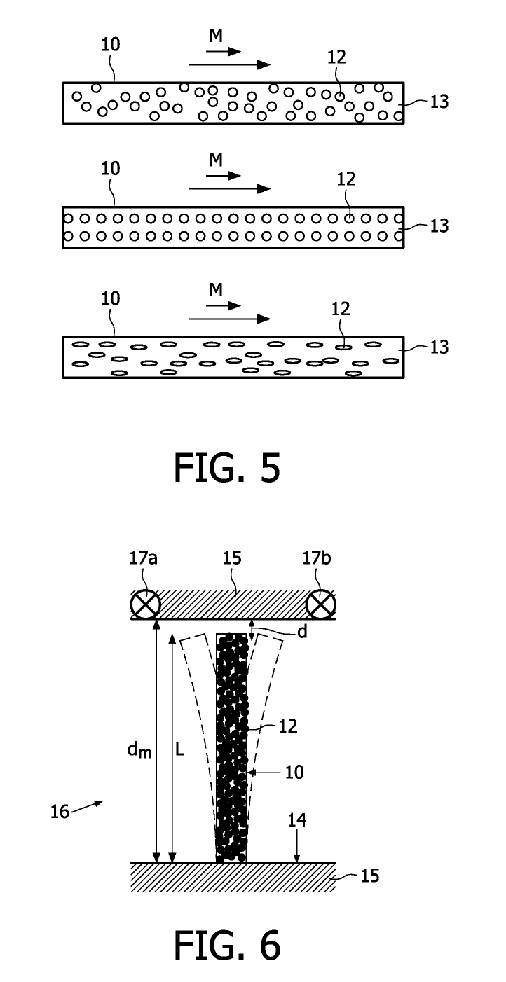

Another way to provide a polymer actuator element 10 with magnetic properties is incorporation of magnetic particles 12 in the polymer actuator element 10. The polymer may in that case function as a ‘matrix’ in which magnetic particles 12 are dispersed, as is illustrated in FIG. 5, and will further be referred to as polymer matrix 13. The magnetic particles 12 may be added to the polymer in solution or may be added to monomers that, later on, then can be polymerized. In a subsequent step, the polymer may then be applied to the wall of the microchannel of the microfluidic system by any suitable method, e.g. by a wet deposition technique such as e.g. spin-coating. The magnetic particles 12 may for example be spherical, as illustrated in the upper two drawings in FIG. 5 or may be elongate, e.g. rod-shaped, as illustrated in the lower drawing in FIG. 5. The rod-shaped magnetic particles 12 may have the advantage that they may automatically be aligned by shear flow during the deposition process. The magnetic particles 12 may be randomly arranged in the polymer matrix 13, as illustrated in the upper and lower drawing of FIG. 5, or they may be arranged or aligned in the polymer matrix 13 in a regular pattern, e.g. in rows and/or columns, as is illustrated in the drawing in the middle of FIG. 5.

The magnetic particles 12 may, for example, be ferro- or ferri-magnetic particles, or (super)paramagnetic particles, comprising, for example, elements such as cobalt, nickel, iron, ferrites. According to embodiments of the invention, the magnetic particles 12 may be superparamagnetic particles, i.e. they do not have a remanent magnetic field when an applied magnetic field has been switched off, especially when elastic recovery of the polymer is slow compared to magnetic field modulation. Long off-times of the magnetic field may save power consumption.

During deposition, a magnetic field may be used to move and align the magnetic particles 12, such that the net magnetization is directed, for example, in the length-direction of the magnetic actuator element 10. In case the magnetic particles 12 are superparamagnetic particles, applying a magnetic field in a certain direction during deposition will facilitate the later magnetization of the actuator element 10 in that same direction because of particle dipolar interactions.

In the following description, the actuator elements 12 such as polymer actuator elements may also be referred to as actuators, e.g. polymer actuators or micropolymer actuators, actuator elements, micropolymer actuator elements or polymer actuator elements. It has to be noticed that when any of these terms is used in the further description always the same microscopic actuator elements according to the invention are meant.

In preferred embodiments, the actuator elements 12 with magnetic properties, when not actuated, are located on a channel wall in a direction substantially perpendicular to the channel wall. With substantially perpendicular is meant that they may include an angle of preferably not more than 45° with the normal to the channel wall. If an actuator element 12 with magnetic properties, when not actuated, has a curved shape, its direction with respect to the normal to the channel wall may be determined by the angle included between the normal to the channel wall and a straight line through both extremities of the actuator element 12.

According to the present invention, the polymer actuator elements 10 with magnetic properties can be actuated by applying a magnetic field. The magnetic field may be generated by sending a current through at least one current wire present in a wall of the at least one microchannel of a microfluidic system. The at least one current wire is located in the wall at a location substantially opposite, with respect to a centre line of the microchannel, to the location where the polymer actuator elements 10 are located, e.g. attached to the wall. Using current wires integrated in the microchannel of the microfluidic system and located substantially opposite, with respect to a centre line of the microchannel, to the location of the polymer actuator elements 10 with magnetic properties enables to bring the current wire closer to the tip of polymer actuator element 10 with respect to prior art microfluidic systems where current wires are located in the wall of the microchannel at a same location as where the polymer actuator element 10 are attached to the wall of the microchannel. This increases the effective force acting on the polymer actuator element 10, when assuming that a similar current is sent through the integrated current wires in the microfluidic system according to embodiments of the present invention as through the integrated current wires of the microfluidic system according to the prior art.

Embodiments of the present invention will be described by means of polymer actuator elements 10 comprising magnetic particles 12. It has to be understood, however, that this is only an example and is not intended to limit the invention in any way. Any suitable actuator elements 10 having magnetic properties or of which the shape and/or orientation properties can be changed by applying a magnetic field may be used with the present invention.

According to a first embodiment, which is illustrated in FIG. 6, the polymer actuator element 10 comprising magnetic particles 12 is attached to a surface 14 of a wall 15 of a microchannel 16 at a first location. Two current wires 17a and 17b are integrated in the wall 15 of the microchannel 16 at a second location which is substantially opposite to the first location with respect to a centreline of the microchannel 16. According to this embodiment, the integrated current wires 17a and 17b may be located above the polymer actuator element 10 at either side of the tip of the actuator element 10, if the actuator element 10 is attached to the wall 15 of the microchannel 16 at its bottom side. A current may be sent through one of the current wires 17a or 17b for generating a magnetic field with magnitude sufficient to cause a change in the shape and/or orientation of the polymer actuator element 10. The current may preferably be between 0.01 A and 10 A, preferably between 0.01 A and 5 A, more preferably between 0.01 A and 1 A. The magnitude of the generated magnetic field depends on the current sent through the current wires 17a or 17b.

The generated magnetic field actuates the polymer actuator element 10 and causes it to bend or more in general, to change its shape. This is because the gradient of the magnetic field generated by sending current through one of the current wires 17a or 17b is directed towards that current wire 17a respectively 17b. Because of the generated magnetic field the actuator element 10 will experience a force directed towards the current wire 17a or 17b respectively according to equation (1). The force is, in first approximation, parallel to the gradient of the generated magnetic field. This will cause the actuator element 10 to bend towards either the current wire 17a or current wire 17b, depending on through which current wire 17a or 17b current is sent. In other words, by sending a current through one of the current wires 17a or 17b the polymer actuator element 10 with magnetic properties may be set in motion. This is illustrated by the dashed lines in FIG. 6.

The polymer actuator element 10 may have a length L between 10 and 200 μm and may typically be 50 μm, and may have a width (dimension disappearing in the plane of the paper showing FIG. 6) of between 1 and 200 μm, typically 50 μm. The polymer actuator element 10 with magnetic properties may have a thickness of between 0.1 and 20 μm, typically 5 μm. The diameter dₘ of the microchannel 16 may preferably be such that the distance d between the current wire 17 and the polymer actuator element 10 in its most stretched, e.g. straight, configuration, i.e. coming closest to the wall 15 of the microchannel 16 wherein the current wires 17a, 17b are provided, is between 0 and 20 μm, preferably between 0 and 5 μm and most preferably between 0 and 1 μm.

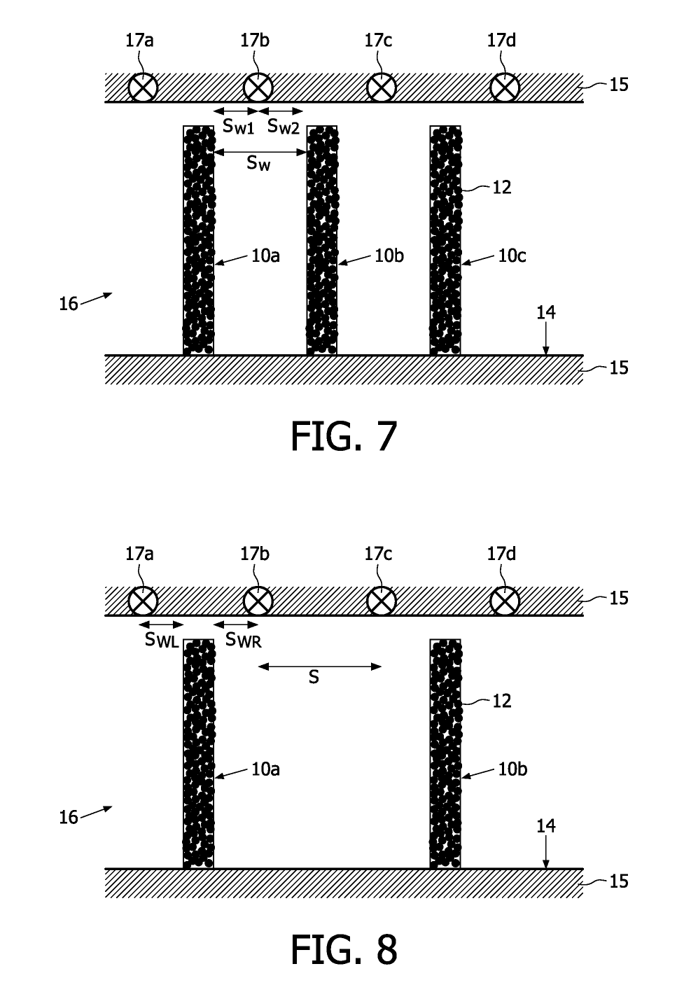

According to the present embodiment, when a plurality of polymer actuator elements 10a, 10b, 10c are attached to the inner surface 14 of the wall 15 of the microchannel 16, a current wire 17a-d may be present in between subsequent polymer actuator elements 10 (see FIG. 7). When a current wire 17a-d is located in between a first polymer actuator element 10a and a second polymer actuator element 10b (see FIG. 7), the distance between the first and second polymer actuator element 10a, 10b being indicated by S_{w}, each of the current wires 17a-d may be located at a first distance S_{w1} from the first polymer actuator element 10a and at a second distance S_{w2} from the second polymer actuator element 10b. According to embodiments of the invention, S_{w1} may be equal to S_{w2} for at least one of the current wires 17a-d. In this case, at least one of the current wires 17a-d may be positioned in the middle in between two subsequent polymer actuator elements 10a, 10b. According to a preferred embodiment, all current wires 17a-d may be positioned in the middle in between two subsequent polymer actuator elements 10a-c, except for the first and the last one in the series. In operation, when, for example, current wire 17b is located in the middle between polymer actuator elements 10a and 10b and a current is sent through the current wire 17b, both polymer actuator elements 10a and 10b will be actuated at a same time. Therefore, according to preferred embodiments, the first distance S_{w1} may be different from the second distance S_{w2}. For example, the first distance S_{w1} may be smaller than the second distance S_{w2}. In this case, the positioning of the current wires 17a-d is asymmetric with respect to the positioning of the actuator elements 10a-c so that one single polymer actuator element 10a-c may be mainly addressed by a single current wire 17a-d. When S_{w1} is smaller than S_{w2} the polymer actuator elements 10a-c will be actuated by the current wire 17a-d positioned closest to that polymer actuator element 10a-c. According to other embodiments of the invention, S_{w2} may be smaller than S_{w1}.

According to yet other embodiments of the invention, each polymer actuator element 10a, 10b may be associated with two actuation current wires for actuation, as indicated in FIG. 8. In that configuration two current wires 17a and 17b may be placed on either side of the polymer actuator element-10a at a distance S_{WL} and S_{WR} respectively in order to mainly actuate the polymer actuator element 10a individually from the polymer actuator element 10b. Another two current wires 17c and 17d may be placed on either side of the polymer actuator element 10b. The current wire 17c may be placed in between polymer actuator elements 10a and 10b at a distance S from current wire 17b for actuating polymer actuator element 10a, such that this current wire 17c for actuating polymer actuator element 10b is closer to the polymer actuator element 10b than to the actuator element 10a. When a current is sent through the current wires 17a and 17b associated with the first polymer actuator element 10a for actuation, mainly that first polymer actuator element 10a will be addressed by the magnetic stimuli. When a current is sent through the current wires 17c and 17d associated with the second polymer actuator element 10b for actuation, mainly the polymer actuator element 10b will be addressed. An advantage of these embodiments is that a plurality of polymer actuator elements 10 can be addressed individually. This can be beneficial for creating complex fluid manipulations.

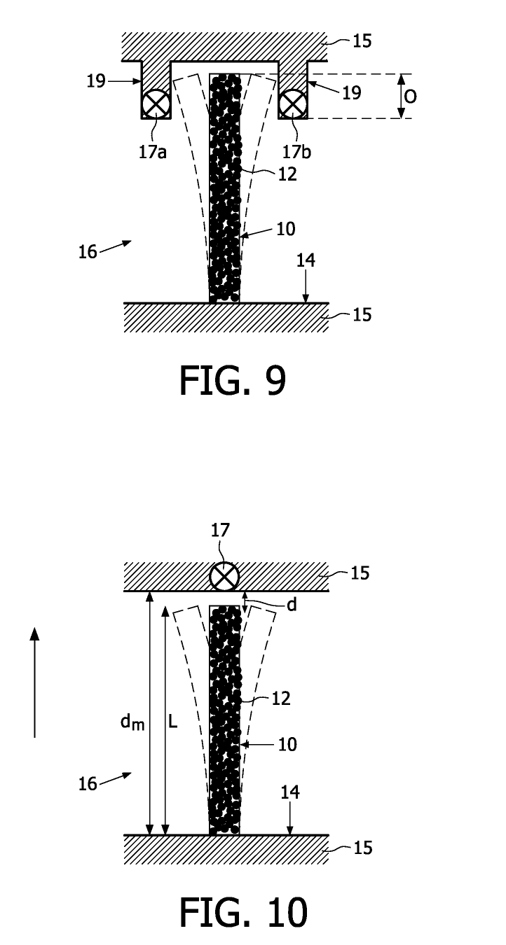

According to another embodiment, the wall 15 of the microchannel 16 at the second location opposite, with respect to the centre line of the microchannel 16, to the first location to which the polymer actuator elements 10 are attached may comprise protrusions 19 extending from the inner surface 14 of the wall 15 into the microchannel 16 (see FIG. 9). The protrusions 19 may be such that they extend further into the microchannel 16 than the space left between the tip of the polymer actuator elements 10 and the inner surface 14 of the wall 15 of the microchannel 16, i.e. they show an overlap O with the polymer actuator element 10, as illustrated in FIG. 9. The overlap O may be between 0 and 50 μm, preferably between 0 and 20 μm and most preferably between 0 and 3 μm. According to these embodiments, the current wires 17 may be located in the protrusions 19. In that way, the current wires 17 can be located closer to the tip of the polymer actuator elements 10. Hence, less current has to be sent through the current wires 17 in order to sufficiently actuate the polymer actuator elements 10 for making the micro fluidic system suitable for being used for mixing, transporting, directing, or otherwise manipulating fluids in the microchannels 16 of the microfluidic system. According to these embodiments, because the current wires 17 may be located in the protrusions 19, they can be located closer to the tip of the polymer actuator elements 10 than when the wall 15 at the second location does not comprise protrusions 19.

According to still further embodiments, the actuation of polymer actuator elements 10 may be induced by a combination of an externally applied uniform magnetic field Bₑₓₜₑᵣₙₐₗ and a locally applied non-uniform magnetic field provided through a current wire 17 in a similar way as in previous embodiments. The external magnetic field can for example be obtained by placing a large magnet (millimetre sized), or a coil or an electromagnet next to the microchannel 16. The external magnetic field may be applied in a direction substantially perpendicular to the wall 15 of the microchannel 16 to which the polymer actuator element 10 is attached. At least one current wire 17 may, according to embodiments of the present invention, be integrated in the wall 15 of the microchannel 16 at a second location that is substantially opposite to the first location where the polymer actuator element 10 is attached to the wall 15 of the microchannel 16, with respect to a centreline of the microchannel 16, as indicated in FIG. 10. The at least one current wire 17 may be located right above the polymer actuator element 10.

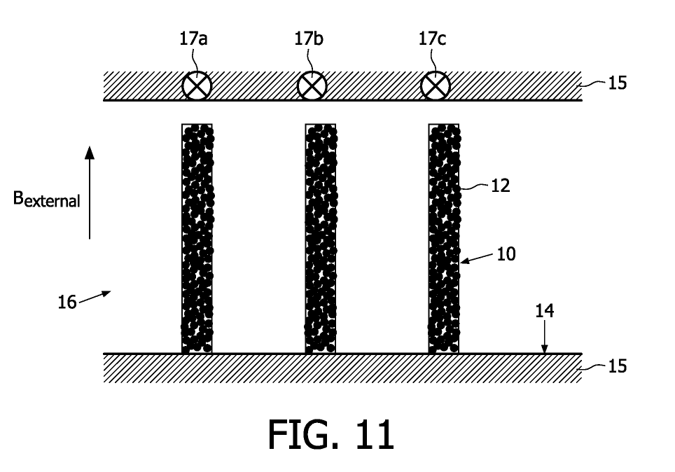

According to the present embodiment of the invention and as illustrated in FIG. 11, a plurality of polymer actuator elements 10 may be attached to the inner surface 14 of the wall 15 of the microchannel 16, a separate current wire 17a, 17b, 17c may be provided for each of the plurality of polymer actuator elements 10 with magnetic properties. Each current wire 17a, 17b, 17c, together with an externally applied homogeneous magnetic field Bₑₓₜₑᵣₙₐₗ, sets its corresponding polymer actuator element 10 with magnetic properties in motion when a current is sent through the current wires 17a, 17b, 17c for generating a magnetic field. In this way, each polymer actuator element 10 with magnetic properties can be addressed individually in order to achieve a required fluid manipulation. By individually addressing the polymer actuator elements 10 a wave-like, correlated or uncorrelated movement may be generated that can be advantageous in transporting, mixing or creating vortices. Individual addressing can also be helpful in the case a set of valves have to be addressed individually in a microfluidic circuitry.

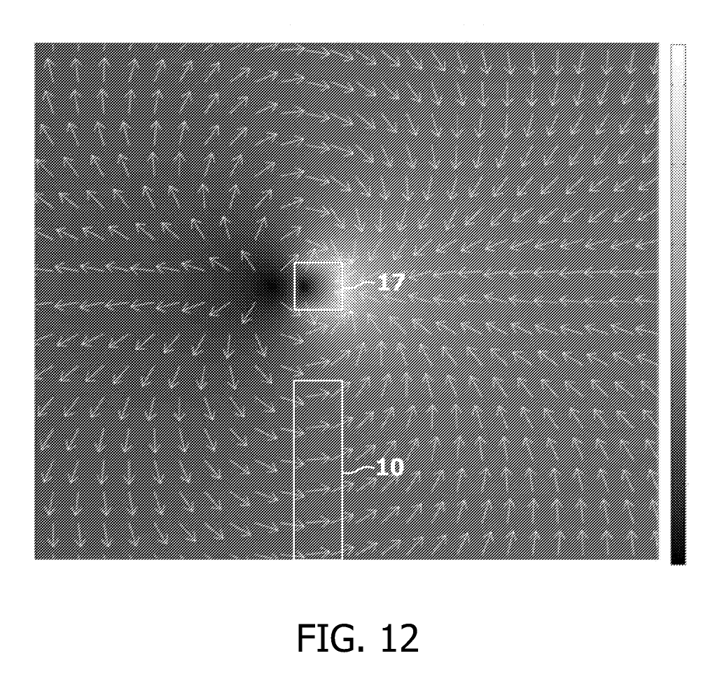

According to the present embodiment illustrated in FIGS. 10 and 11, the total magnetic field gradient for actuating the polymer actuator element 10 may be substantially perpendicular to the polymer actuator element 10 at the location of the tip of the polymer actuator element 10. This can be seen in FIG. 12 where the arrows indicate the direction of the magnetic field gradient of a magnetic field being the combination of a homogeneous vertical field of 200 mT and a magnetic field generated by sending a current of 1 A through the current wire 17 located as illustrated in FIG. 10. According to equation (1), the direction of the force on the polymer actuator element 10 will be collinear with the field gradient direction. In the simulation of FIG. 12 the direction of the vertical external homogeneous magnetic field may be from bottom to top, as indicated in FIG. 10, and the current in the current wire 17 may be flowing out of the plane of the image. The movement of the polymer actuator element 10 will be in a direction to the right side of the paper. According to other embodiments, the current in the current wire 17 may also flow into the plane of the image and in that case the polymer actuator element 10 will move to the left of the paper. In other words, the direction of movement of the polymer actuator element 10 will depend on the direction of the current sent through the current wire 17.

The value of the magnetic field gradient for the simulation in FIG. 12 is 2.5·10⁵ A/m² at the position of the tip of the polymer actuator element 10 and a good approximation for the force per area exerted on the polymer actuator element can be given considering equation (1), a uniform magnetization and a uniform magnetic field gradient over the tip of the polymer actuator element 10 (the tip being defined as the surface that has equal width and thickness as the polymer actuator element 10 and being located furthest away from a base or bottom side of the polymer actuator element 10):

Fₐ=μ₀·Mₛₐₜ·Cᵥ·dH·A (2)

wherein μ₀ is the permeability of free space, Mₛₐₜ the saturation magnetization of iron oxide (5·10⁵ A/m), Cᵥ the volume concentration of superparamagnetic iron oxide particles in the polymer actuator element (0.1), dH the magnetic field gradient (2.5·10⁵ A/m²) and A the surface area of the tip (1×1 square microns).

Using the following basic formula for deflection of a beam with point surface load at the tip together with equation (2), the deflection of the polymer actuator element 10 can be approximated by:

$$δ = \frac{4 \cdot {F}_{a} \cdot {L}^{3}}{E \cdot {W}^{3}} \qquad ( 3 )$$

wherein L is the height of the polymer actuator element 10 (e.g. 10 microns), W the width of the polymer actuator element (e.g. 1 micron) and E the Young's modulus of the polymer actuator element (1 Mpa).

Combining equation (2) and (3), it can be seen that the deflection reaches 6.3 micron, which is significant enough to induce fluid motion in the microchannel 16 for the given size of the polymer actuator element 10 in this example.

It has to be noted that, in case the fluid in the microchannels 16 comprises magnetic particles 12, the external magnetic field Bₑₓₜₑᵣₙₐₗ should be limited to avoid unwanted particle clustering and subsequent sedimentation of these clusters in the fluid.

The present embodiment provides improved actuation compared to prior art at equal or lower currents by the placement of the current wire 17 being closer to the tip of the polymer actuator element 10 and the magnetization of the polymer actuator element 10 being substantially higher due to the external magnetic field. The external magnetic field may be between 0 and 1 T, preferably between 0 and 500 mT and most preferably between 100 and 200 mT. The current in the current wire 17 may be between 0.01 A and 10 A, preferably between 0.01 A and 5 A and most preferably between 0.01 A and 1 A.

Similar to what was already discussed in the first embodiment, the polymer actuator element 10 may have a length L between 10 μm and 200 μm and may typically be 50 μm, and may have a width of between 1 μm and 200 μm, typically 50 μm. The polymer actuator element 10 may have a thickness of between 0.1 μm and 20 μm, typically 5 μm. The diameter dₘ of the microchannel 16 may preferably be such that the distance d between the current wire 17 and the polymer actuator element 10 is between 0 μm and 20 μm, preferably between 0 μm and 5 μm and most preferably between 0 μm and 1 μm.

Due to the location of the current wires 17 as described in the above embodiments of the invention, good actuation and thus good deformation of the polymer actuator elements 10 with magnetic properties can be obtained and thus the micro fluidic system according to embodiments of the invention is suitable for being used for transporting, mixing, directing, or manipulating fluids in microchannels 16 of the micro fluidic system. This is illustrated hereinafter for polymer actuator elements 10 comprising superparamagnetic particles 12.

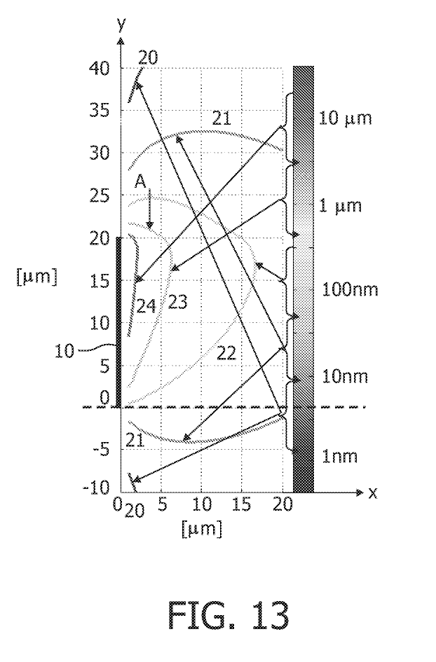

A superparamagnetic particle 12 placed next to a current wire 17 may be magnetized by a magnetic field generated by sending current through the current wire 17 and in that way the particle 12 gets a magnetization M. The magnetized particle senses a translational force F as expressed in equation (1). A polymer actuator element 10 comprising such superparamagnetic particles 12 and being placed next to a current wire 17 will move in a direction of the gradient of the magnetic field, or in other words will move towards the current wire 17. FIG. 13 shows a finite element simulation of an actuator element 10 actuated by current wires 17 located at different locations. The lines indicated with reference numbers 20 to 24 represent possible locations of the current wire 17 (at coordinates x:y) for given deflection at the tip of the polymer actuator element 10, given the following assumptions:

Low magnetic induction (<20 mT, not reaching saturation magnetization of the polymer actuator element 10).

Low particle fraction (<0.2, field lines not significantly modified due to the magnetic polymer actuator element 10).

Small deformations (force does not change with deformation).

Young's modulus of the polymer actuator element=10 Mpa (for example, PDMS (poly(dimethylsiloxane)) or PBMA (poly(buthylmetacrylate)) have a Young's modulus in this range).

Current through the current wire=200 mA.

Aspect ratio of the polymer actuator element 10=40 (20 μm×0.5 μm). Fabrication can, for example, be provided through ion beam lithography.

Fraction of iron oxide nano-particles in the polymer actuator element=0.2

If the current wire 17 is located as described in the embodiments above, for example at locations with coordinates x:y equal to 3:21 or 5:12 (respectively indicated by A and B in FIG. 13) it can be seen that deformation of the polymer actuator element 10 reaches the order of magnitude of microns and hence, effective fluid manipulation will occur in the microfluidic system according to embodiments of the present invention.

In the above-described embodiments, the movement of the actuator elements 10 may be measured by, for example, one or more magnetic sensors positioned in the microfluidic system. This may allow determining flow properties such as, for example, flow speed and/or viscosity of the fluid in the microchannel 16. Furthermore, other fluid details may be measured by using different actuation frequencies. For example, the cell content of the fluid, for example the hematocrit value, or the coagulation properties of the fluid, could be measured in that way.

An advantage of the micro fluidic system according to embodiments of the present invention is that, because of the use of magnetic actuation, they may work with very complex biological fluids such as e.g. saliva, sputum or full blood.

A further advantage of the microfluidic system according to embodiments of the present invention is that it provides enhanced actuation effects at equal or lower electrical currents with respect to prior art microfluidic systems in which magnetic actuation is obtained by a magnetic field generated by a current wire located in the wall of the microchannel.

The microfluidic system according to embodiments of the present invention may be used in biotechnological or biomedical applications such as biosensors, rapid DNA separation and sizing, cell manipulation and sorting, or in pharmaceutical applications, in particular high-throughput combinatorial testing where local mixing is essential. The microfluidic system according to embodiments of the present invention may also be used in microchannel cooling systems in microelectronics applications.

For example, the microfluidic system of the present invention may be used in biosensors for, for example, the detection of at least one target molecule, such as proteins, antibodies, nucleic acids (e.g. DNR, RNA), peptides, oligo- or polysaccharides or sugars, in, for example, biological fluids, such as saliva, sputum, blood, blood plasma, interstitial fluid or urine. Therefore, a small sample of the fluid (e.g. a droplet) is supplied to the system, and by manipulation of the fluid within a microchannel system, the fluid is let to the sensing position where the actual detection takes place. By using various sensors in the microfluidic system according to embodiments of the present invention, different types of target molecules may be detected in one analysis run.

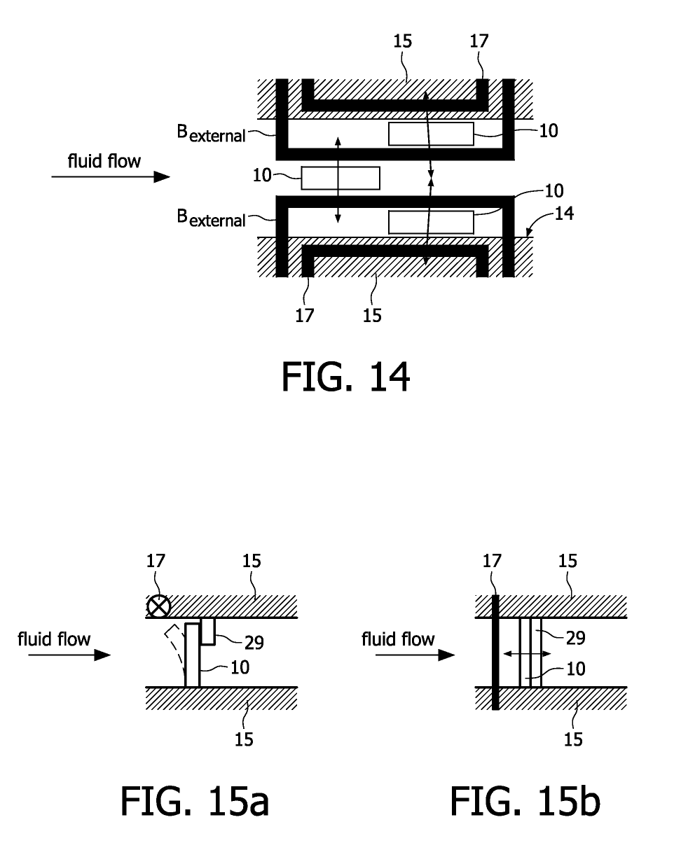

FIGS. 14 and 15 illustrate possible applications of the microfluidic system according to embodiments of the present invention.

FIG. 14 is a partially broken away top view of a configuration of a microfluidic system which can be used for mixing fluids. The microfluidic system illustrated in this figure may comprise a plurality of current wires 17, 28 integrated in the top wall of the microchannel 16, the top wall being taken away for clarity of the top view. The arrows in the drawing indicate the movement of the polymer actuator elements 10. The current wires 17, 28 and the polymer actuator elements 10 are located with respect to each other as the current wires 17a-d and the polymer actuator elements 10 illustrated in FIG. 7, but their orientation with respect to the microchannel 16 is different. In the embodiment of FIG. 7, the polymer actuator elements 10 are positioned with their width in the direction of the width of the microchannel 16, while in the embodiment of FIG. 14 the actuator elements 10 are positioned with their width in the direction of the length of the microchannel 16. Correspondingly, in the embodiment of FIG. 7, the current wires run along the width of the microchannel 16, while in the embodiment of FIG. 14, the current wires run along the length of the microchannel 16. The embodiment of FIG. 7 may be used for mixing or pumping, while the embodiment of FIG. 14 may be mainly used for mixing.

FIG. 15(a) is a cross-section and FIG. 15(b) is a partially broken away top view of a microfluidic system in accordance with embodiments of the present invention which can be used for directing fluids. The microfluidic system according to this example comprises a stopper element 29 located at a first side of the polymer actuator element 10, in the example given the right side of the polymer actuator element 10, and which limits the movement of the polymer actuator element 10 in a first direction, in the example given in the direction to the right of the drawing, which in the example given also is the direction of the fluid flow. The current wire 17 may be located at a second side of the polymer actuator element 10, in the example given the left side of the polymer actuator element 10. By actuating the polymer actuator element 10 by sending current through the current wire 17 the microchannel 16 may be opened and closed. The embodiment illustrated in FIG. 15 may thus provide valve action.

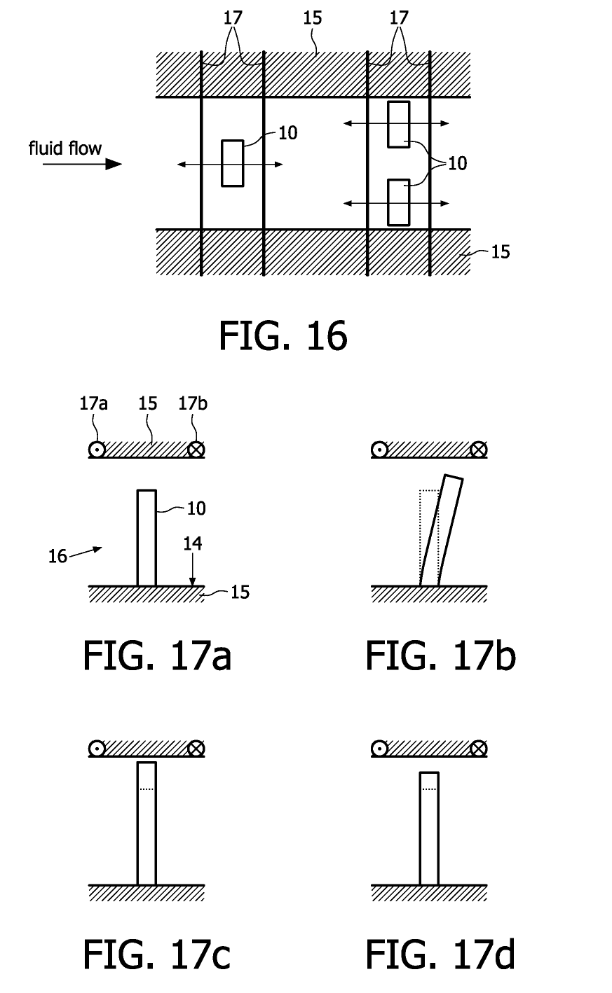

FIG. 16 is a partially broken away top view of a microfluidic system in accordance with embodiments of the present invention which can be used for pumping or mixing. The microfluidic system according to this example shows a plurality of actuator elements 10, not all located in row over the length of the microchannel 16. In the example illustrated, two polymer actuator elements 10 are positioned next to each other in the width of the microchannel 16, while a third polymer actuator element 10 is positioned in the middle of the width of the microchannel 16, at a distance from the two polymer actuator elements 10. The microfluidic system is provided with two current wires 17 positioned at either side of the single polymer actuator elements 10, an with two current wires 17 positioned at either side of the set of two polymer actuator elements 10 next to each other in the width direction of the microchannel 16. This means that the two polymer actuator elements 10 next to each other in the width direction of the microchannel 16 can be actuated together, where separate therefrom the single polymer actuator element 10 can be actuated.

FIG. 17 illustrates part of a microfluidic system according to embodiments of the invention. The micro fluidic system may comprise a single polymer actuator element 10 and two current wires 17a and 17b. In the microfluidic system according to the embodiment illustrated in FIG. 17 a specific actuation scheme of the current wires 17a, 17b is used which induces an asymmetric movement of the polymer actuator element 10. This can be advantageous for certain fluid manipulations as was already discussed above. In FIG. 17(a) no current is running through the current wires 17a and 17b and consequently the polymer actuator element 10 is not deformed. In FIG. 17(b), a current is running in a direction into the plane of the drawing in wire 17b and no current is running in wire 17a. As a result, the polymer actuator element 10 is deformed towards the current wire 17b. In FIG. 17(c), equal currents are running in both wires 17a and 17b but in opposite directions, i.e. the current is running in a direction into the plane of the drawing in wire 17b and in a direction out of the plane of the drawing in wire 17a. The point of highest intensity of magnetic field is in this case situated in between the two wires 17a and 17b, i.e. the gradient of the magnetic field is pointing towards that point, and is thus situated above the polymer actuator element 10. In this case, the polymer actuator element 10 is attracted towards that point of highest gradient. When the wall 15 the polymer actuator element 10 is attached to is lying in a plane, the actuator element 10 is thus attracted upwards in a direction substantially perpendicular to the plane of the wall 15 and, hence, is in a straight and stretched deformation as illustrated in FIG. 17(c). In FIG. 17(d) the current in both current wires 17a, 17b is running in a same direction as was discussed for the case in FIG. 17(c). However, in the case illustrated in FIG. 17(d) the intensity of the currents is lower than in FIG. 17(c) but both currents are still equal for both current wires 17a and 17b. The polymer actuator element 10 is thus in a straight stretched situation for the same reason as set out for the case in FIG. 17(c) but now the polymer actuator element 10 is less stretched than in the situation of FIG. 17(c) because the intensity of the currents is lower. When the current is stopped from flowing through the current wires 17a, 17b in the situation in FIG. 17(c) or FIG. 17(d), the polymer actuator element 10 returns to the initial position of FIG. 17(a), i.e. takes its initial shape. This shows that an asymmetrical movement of the polymer actuator element 10 can be achieved by sequentially applying the currents as described hereinabove or in any other similar way.

It has to be noted that that mixing and pumping need different driving schemes for the collective movement of the polymer actuator elements 10, particularly the phase difference in movement between neighbouring polymer actuator elements 10 plays an important role.

Hereinafter, the polymer actuator elements 10 which may be used in the microfluidic system according to embodiments of the present invention will be discussed in some more detail.

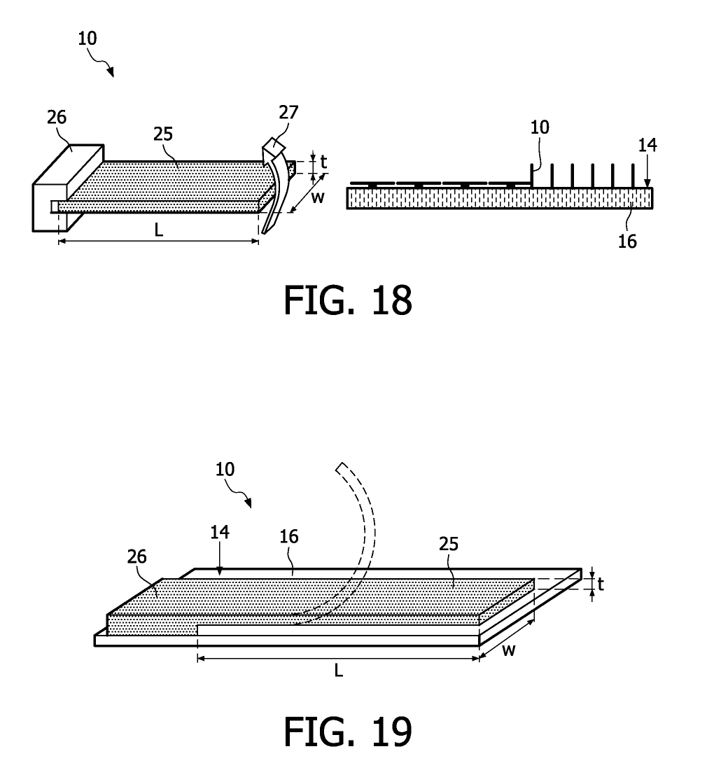

FIG. 18 and FIG. 19 illustrate an example of a polymer actuator element 10. The left hand part of FIG. 18 represents an actuator element 10 which may respond to an applied magnetic field by bending up and down. The right hand part of FIG. 18 illustrates a cross-section in a direction perpendicular to a wall 15 of a microchannel 16 which is covered with actuator elements 10. The actuator elements 10 in the right hand part of FIG. 18 may respond to an applied magnetic field by bending from the left to the right.

The polymer actuator element 10 may comprise a polymer Micro-Electro-Mechanical System or polymer MEMS 25 and an attachment means 26 for attaching the polymer MEMS 25 to the inner surface 14 of the wall 15 of the microchannel 16 of the microfluidic system. The attachment means 26 can be positioned at a first extremity of the polymer MEMS 25. The polymer MEMS 25 may have the shape of a beam. However, the invention is not limited to beam-shaped MEMS, the polymer actuator element 10 may also comprise polymer MEMS 25 having other suitable shapes, preferably elongate shapes, such as for example the shape of a rod.

An embodiment of how to form a polymer actuator element 10 attached to the inner surface 14 of a wall 15 of a microchannel 16 will be described hereinafter.

The polymer actuator elements 10 may be fixed to the inner surface 14 of the wall 15 of a microchannel 16 in various possible ways. A first way to fix the polymer actuator elements 10 to the inner surface 14 of the wall 15 of a microchannel 16 is by depositing, for example by spinning, evaporation or by another suitable deposition technique, a layer of material out of which the polymer actuator elements 10 will be formed on a sacrificial layer. Therefore, first a sacrificial layer may be deposited on the inner surface 14 of a wall 15 of the micro-channel 16. The sacrificial layer may, for example, be composed of a metal (e.g. aluminum), an oxide (e.g. SiOx), a nitride (e.g. SixNy) or a polymer. The material the sacrificial layer is composed of should be such that it can be selectively etched with respect to the material the polymer actuator element 10 is formed of and may be deposited on the inner surface 14 of a wall 15 of the microchannel 16 over a suitable length. According to embodiments of the invention the sacrificial layer may, for example, be deposited over the whole inner surface area of the wall 15 of a microchannel 16, typically areas in the order of several cm. However, according to other embodiments, the sacrificial layer may be deposited over a length L, which length L may then be the same length as the length of the actuator element 10, which may typically be between 10 to 200 μm. Depending on the material used, the sacrificial layer may have a thickness of between 0.1 and 10 μm.

In a next step, a layer of polymer material, which later will form the polymer MEMS 25, is deposited over the sacrificial layer and next to one side of the sacrificial layer. Subsequently, the sacrificial layer may be removed by etching the sacrificial layer underneath the polymer MEMS 25. In that way, the polymer layer is released from the inner surface 14 of the wall 15 over the length L (as illustrated in FIG. 18), this part forming the polymer MEMS 25. The part of the polymer layer that stays attached to the inner surface 14 of the wall 15 forms the attachment means 26 for attaching the polymer MEMS 25 to the microchannel 16, more particularly to the inner surface 14 of the wall 15 of the microchannel 16.

Another way to form polymer actuator elements 10 which can be used with the present invention may be by using patterned surface energy engineering of the inner surface 14 of the wall 15 before applying the polymer material. In that case, the inner surface 14 of the wall 15 of the microchannel 16 on which the polymer actuator elements 10 will be attached is patterned in such a way that regions with different surface energies are obtained. This can be done with suitable techniques such as, for example, lithography or printing. Therefor, the layer of material out of which the polymer actuator elements 10 will be constructed is deposited and structured, each with suitable techniques known by a person skilled in the art. The layer will attach strongly to some areas of the inner surface 14 of the wall 15 underneath, further referred to as strong adhesion areas, and weakly to other areas of the inner surface 14 of the wall 15, further referred to as weak adhesion areas. It may then be possible to get spontaneous release of the layer at the weak adhesion areas, whereas the layer will remain fixed at the strong adhesion areas. The strong adhesion areas may then form the attachment means 26. In that way it is thus possible to obtain self-forming free-standing polymer actuator elements 10.

The polymer MEMS 25 may, for example, comprise an acrylate polymer, a poly(ethylene glycol) polymer comprising copolymers, or may comprise any other suitable polymer. Preferably, the polymers the polymer MEMS 25 are formed of should be biocompatible polymers such that they have minimal (bio)chemical interactions with the fluid in the microchannels 16 or the components of the fluid in the microchannels 16. Alternatively, the polymer actuator elements 10 may be modified so as to control non-specific adsorption properties and wettability. The polymer MEMS 25 may, for example, comprise a composite material. For example, it may comprise a particle-filled matrix material or a multilayer structure. It could also be mentioned that “liquid crystal polymer network materials” may be used in accordance with the present invention.

The polymer MEMS 25 may, for example, also be fabricated with PDMS (poly(dimethylsiloxane)) being filled with magnetic particles. The polymer MEMS 25 may be structured into a polymer actuator element 10, e.g. a slab, for example by curing PDMS filled with magnetic particles in a mould. The necessary mould for this process may, for example, be fabricated by performing UV-lithography or ion-beam lithography into a photoresist which may be PMMA (poly(methylmetacrylate)) or SU-8 (epoxy based photoresist). In order to release high aspect ratio PDMS polymer actuator elements 10 from the mould, a double mould process may be used as was indicated in “Soft Lithography, Younan Xia and George M. Whitesides, annu. Rev. Mater. Sci. 1998 28:153-84” and in “Cells lying on a bed of microneedles, J. Tan, J. Tien, D. Pirone, D. Gray, K. Bhadriraju, C. Chen, PNAS, February 2003, vol. 100, p. 1484-1489”.

In a non-actuated state, i.e. when no magnetic field is applied to the polymer actuator elements 10, the polymer MEMS 25 which, in a specific example, may have the form of a beam, are either curved or straight. A magnetic field applied to the polymer actuator elements 10a-d causes them to bend or straighten out or in other words, causes them to be set in motion. The change in shape of the polymer actuator elements 10 sets the surrounding fluid, which is present in the microchannel 16 of the microfluidic system, in motion. In FIG. 18 the bending of the polymer MEMS 25 is indicated by arrow 27 and in FIG. 19 this is illustrated by the dashed line. Due to the fixation to the inner surface 14 of the wall 15 of one extremity of the polymer actuator element 10, the movement obtained resembles that of the movement of the cilia described earlier.

According to the above-described aspect of the invention, the polymer MEMS 25 may have a length L of between 10 and 200 μm and may typically be 50 μm, and may have a width w of between 1 and 200 μm, typically 50 μm. The polymer MEMS 25 may have a thickness t of between 0.1 and 20 μm, typically 5 μm.

The inner surface 14 of the walls 15 of the microchannels 16, may be covered with a plurality of straight or curled polymer actuator elements 10. The polymer MEMS 25 can move back and forth, under the action of a magnetic field applied to the actuator elements 10. The actuator elements 10 may comprise polymer MEMS 25 which may e.g. have a rod-like shape or a beam-like shape, with their width extending in a direction coming out of the plane of the drawing.

The polymer actuator elements 10 at the inner surface 14 of the walls 15 of the microchannels 16 may be arranged in one or more rows. According to embodiments of to the present invention, the actuator elements 10 may be arranged in a plurality of rows of actuator elements 10 which may be arranged to form, for example, a two-dimensional array. According to still further embodiments, the actuator elements 10 may be randomly positioned at the inner surface 14 of the wall 15 of a microchannel 16.

To be able to transport fluid in a certain direction the movement of the polymer actuator elements 10 must be asymmetric. That is, the nature of the “beating” stroke should be different from that of the “recovery” stroke. This may be achieved by a fast beating stroke and a much slower recovery stroke (see FIG. 2).

For a pumping device the motion of the polymer actuator elements 10 is provided by a metachronic actuator means. This can be done by providing means for addressing the actuator elements 10 either individually or row by row. This may be achieved by providing patterned conductive films that are part of the microchannel wall structure and which may make it possible to create local magnetic fields so that actuator elements 10 can be addressed individually or in rows.

Individual or row-by-row stimulation of the actuator elements 10 may thus be possible when the inner surface 14 of the wall 15 of the microchannel 16 comprises a structured pattern through which the applied magnetic field is activated. By proper addressing in time, a co-ordinated stimulation, for example, in a wave-like manner, is made possible. Non-co-ordinated or random actuator means, symplectic metachronic actuator means and antiplectic metachronic actuator means are included within the scope of the present invention.

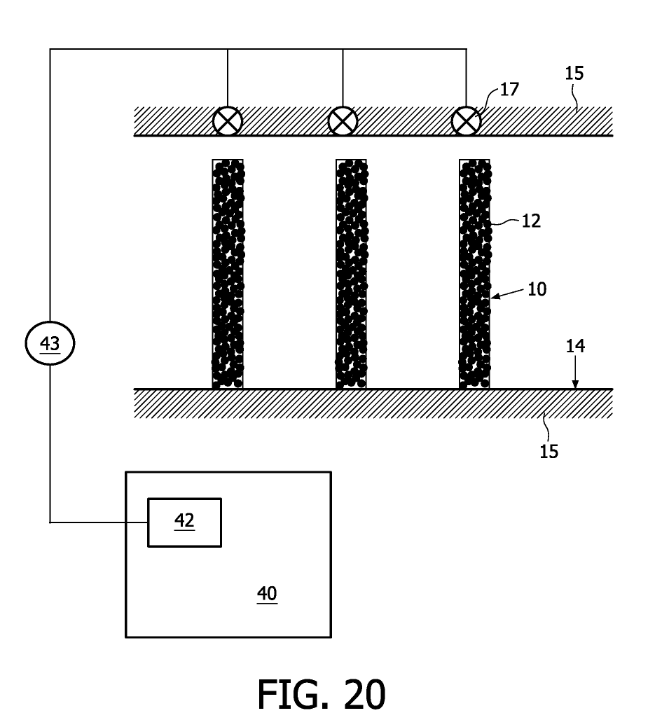

In a further aspect, the present invention also provides a system controller 40 for use in a microfluidic system for controlling a fluid flow through a microchannel 16 of a microfluidic system according to embodiments of the present invention. The system controller 40, which is schematically illustrated in FIG. 20, may control the overall operation of the microfluidic system for controlling a fluid flow through a microchannel 16 of the microfluidic system. The system controller 40 according to the present aspect may comprise a control unit 42 for controlling a magnetic field generator by applying a current through at least one current wire 17 present in the wall 15 of the microchannel 16. The current may for example be applied through a current providing unit 43 such as e.g. a plurality of current or voltage sources. Controlling the at least one current wire 17 may be performed by providing predetermined or calculated control signals to the current providing unit 43. It is clear for a person skilled in the art that the system controller 40 may comprise other control units for controlling other parts of the micro fluidic system; however, such other control units are not illustrated in FIG. 20.

The system controller 40 may include a computing device, e.g. microprocessor, for instance it may be a micro-controller. In particular, it may include a programmable controller, for instance a programmable digital logic device such as a Programmable Array Logic (PAL), a Programmable Logic Array, a Programmable Gate Array, especially a Field Programmable Gate Array (FPGA). The use of an FPGA allows subsequent programming of the microfluidic system, e.g. by downloading the required settings of the FPGA. The system controller 40 may be operated in accordance with settable parameters.

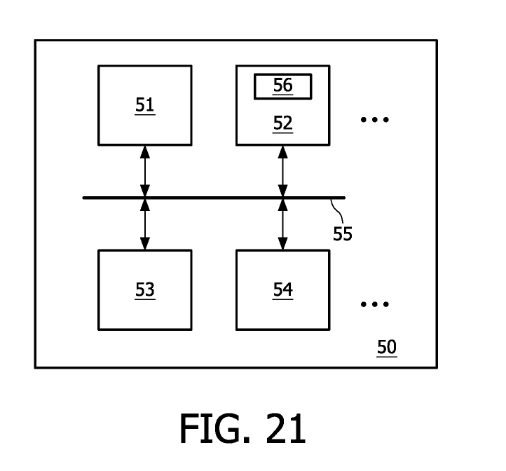

The method for controlling a fluid flow through a microchannel 16 of a microfluidic system according to embodiments of the present invention may be implemented in a processing system 50 such as shown in FIG. 21. FIG. 21 shows one configuration of processing system 50 that includes at least one programmable processor 51 coupled to a memory subsystem 52 that includes at least one form of memory, e.g., RAM, ROM, and so forth. It is to be noted that the processor 51 or processors may be a general purpose, or a special purpose processor, and may be for inclusion in a device, e.g., a chip that has other components that perform other functions. Thus, one or more aspects of the present invention can be implemented in digital electronic circuitry, or in computer hardware, firmware, software, or in combinations of them. The processing system may include a storage subsystem 53 that has at least one disk drive and/or CD-ROM drive and/or DVD drive. In some implementations, a display system, a keyboard, and a pointing device may be included as part of a user interface subsystem 54 to provide for a user to manually input information. Ports for inputting and outputting data, e.g. desired or obtained flow rate, also may be included. More elements such as network connections, interfaces to various devices, and so forth, may be included, but are not illustrated in FIG. 21. The various elements of the processing system 50 may be coupled in various ways, including via a bus subsystem 55 shown in FIG. 21 for simplicity as a single bus, but will be understood to those in the art to include a system of at least one bus. The memory of the memory subsystem 52 may at some time hold part or all (in either case shown as 56) of a set of instructions that when executed on the processing system 50 implement the steps of the method embodiments described herein. Thus, while a processing system 50 such as shown in FIG. 21 is prior art, a system that includes the instructions to implement aspects of the methods for manipulating particles or characterising particles is not prior art, and therefore FIG. 21 is not labelled as prior art.

The present invention also includes a computer program product which provides the functionality of any of the methods according to the present invention when executed on a computing device. Such computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non volatile media includes, for example, optical or magnetic disks, such as a storage device which is part of mass storage. Common forms of computer readable media include, a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network, such as a LAN, a WAN or the Internet. Transmission media can take the form of acoustic or light waves, such as those generated during radio wave and infrared data communications. Transmission media include coaxial cables, copper wire and fibre optics, including the wires that comprise a bus within a computer.

It is to be understood that although preferred embodiments, specific constructions and configurations, as well as materials, have been discussed herein for devices according to the present invention, various changes or modifications in form and detail may be made without departing from the scope and spirit of this invention.

1. A micro fluidic system comprising at least one microchannel (16) having a wall (15) and a centre line along its length, the micro fluidic system furthermore comprising: a plurality of ciliary actuator elements (10) attached to a surface (14) of the wall (15) at a first location, each ciliary actuator element (10) having a shape and an orientation, and a magnetic field generator for applying a magnetic field to the plurality of ciliary actuator elements (10) so as to cause a change in their shape and/or orientation, wherein the magnetic field generator for applying the magnetic field to the plurality of ciliary actuator elements (10) is formed by at least one current wire (17) integrated in the wall (15) of the microchannel (16) at a second location, the second location being substantially opposite to the first location with respect to the centre line of the microchannel (16).

2. A micro fluidic system according to claim 1, the plurality of ciliary actuator elements (10) being positioned subsequently in a row, the micro fluidic system comprising a plurality of current wires (17) integrated in the wall (15) at the second location, wherein a current wire (17) is located in between each two subsequent ciliary actuator elements (10).

3. A micro fluidic system according to claim 1, the micro fluidic system comprising a plurality of current wires (17) integrated in the wall (15) at the second location, wherein a separate current wire (17) is provided for each of the plurality of ciliary actuator elements (10).

4. A micro fluidic system according to claim 1, the wall (15) of the microchannel (16) having at least one protrusion (19) at the second location, wherein the at least one current wire (17) is located in the at least one protrusion (19) of the wall (15).

5. A micro fluidic system according to claim 4, wherein the at least one protrusion (19) shows an overlap (0) with the ciliary actuator elements (10) of between 0 μm and 10 μm.

6. A micro fluidic system according to claim 1, wherein the microfluidic system furthermore comprises an external magnetic field generator.

7. A microfluidic system according to claim 1, wherein the plurality of ciliary actuator elements (10) are polymer actuator elements.

8. A micro-fluidic system according to claim 7, wherein the polymer actuator elements (10) comprise polymer MEMS.

9. A microfluidic system according to claim 1, wherein the ciliary actuator elements (10) comprise one of a uniform continuous magnetic layer (11), a patterned continuous magnetic layer and magnetic particles (12).

10. A microfluidic system according to claim 1, the microfluidic system furthermore comprising at least one magnetic sensor for measuring movement of the plurality of ciliary actuator elements (10).

11. A microfluidic system according to claim 1, furthermore comprising at least one stopper element (29) for limiting the movement of at least one ciliary actuator element (10).

12. Use of the microfluidic system according to claim 1 in biotechnological, pharmaceutical, electrical or electronic applications.

13. A method for the manufacturing of a microfluidic system comprising at least one microchannel (16) having a centre line along its length, the method comprising: providing an inner surface (14) of a wall (15) of the at least one microchannel (16) with a plurality of ciliary actuator elements (10) attached at a first location, and providing at least one current wire (17) in the wall (15) of the at least one microchannel (16) at a second location
wherein the second location is substantially opposite to the first location with respect to the centre line of the microchannel (16).

14. A method as claimed in claim 13, wherein the actuator element comprises a polymer MEMS (25) and an attachment means (26) for attaching the polymer MEMS (25) to the inner surface (14) of the wall (15) of the microchannel (16) and wherein the polymer MEMS (25) is structured into a polymer actuator element (10) by curing poly(dimethylsiloxane) (PDMS) filled with magnetic particles in a mould.

15. A method as claimed in claim 14, wherein the necessary mould for this process is fabricated by performing UV-lithography or ion-beam lithography into a photoresist selected from the group of poly(methylmetacrylate) and epoxy based photoresist.

16. A method according to claim 13, the method comprising providing a plurality of current wires (17), wherein providing the plurality of current wires (17) is performed by providing a current wire (17) in between each two subsequent ciliary actuator elements (10).

17. A method according to claim 13, the method comprising providing a plurality of current wires (17), wherein providing the plurality of current wires (17) is performed by providing a separate current wire (17) for each of the plurality of ciliary actuator elements (10).

18. A method according to claim 13, wherein the method furthermore comprises providing at least one protrusion (19) to the wall (15) of the microchannel (16) at the second location and wherein providing the at least one current wire (17) is performed by providing the at least one current wire (17) in the at least one protrusion (19) of the wall (15).

19. A method according to claim 13, the method furthermore comprising providing at least one stopper element (29) for limiting the movement of at least one ciliary actuator element (10).

20. A method for controlling a fluid flow through a microchannel (16) of a micro fluidic system, the microchannel (16) having a centre line along its length and a wall (15), the wall (15) of the microchannel (16) having a plurality of ciliary actuator elements (10) at a first location, the ciliary actuator elements (10) each having a shape and an orientation; the method comprising: providing a current through at least one current wire (17) present in the wall (15) of the microchannel (16) at a second location substantially opposite to the first location with respect to the centre line of the microchannel (16) for applying a magnetic field to the ciliary actuator elements (10) so as to cause a change in the shape and/or orientation of at least one ciliary actuator element (10).

21. A method according to claim 20, wherein providing a current through at least one current wire (17) is performed by providing a current of between 0.1 A and 10 A.

22. A method according to claim 21, wherein providing a current through at least one current wire (17) is performed by providing a current of between 0.1 A and 1 A.

23. Use of the method according to claim 20 in biotechnological, pharmaceutical, electrical or electronic applications.

24. A controller (40) for controlling a fluid flow through a microchannel (16) of a micro fluidic system, the microchannel (16) having a centre line along its length and a wall (15), the wall (15) of the microchannel (16) having a plurality of ciliary actuator elements (10) at a first location, the ciliary actuator elements (10) each having a shape and an orientation, the controller comprising: a control unit for controlling flowing of a current through at least one current wire (17) present in the wall (15) of the microchannel (16) at a second location substantially opposite to the first location with respect to the centre line of the microchannel (16) for applying a magnetic field to the ciliary actuator elements (10) so as to cause a change in the shape and/or orientation of at least one ciliary actuator element (10).

25. A computer program product for performing, when executed on a computing means, a method as in claim 20.

26. A machine readable data storage device for storing the computer program product of claim 25.

27. Transmission of the computer program product of claim 25 over a local or wide area telecommunications network.
